(19) United States
(12) Patent Application Publication
(10) Pub. No.: US 2009/0132254 A1
(43) Pub. Date: May 21, 2009

(54) DIAGNOSTIC REPORT BASED ON QUALITY OF USER'S REPORT DICTATION

(75) Inventors: Timothy Fitzgerald, Burlington, VT (US); Susan M. Ferguson, Burlington, VT (US); Kimberly Stavrinakis, Richmond, VT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/943,349

(22) Filed: Nov. 20, 2007

(51) Int. Cl. G10L 21/00

(52) U.S. Cl. 704/270; 704/E19.009

(57) ABSTRACT

A system and method are provided for automatically routing a diagnostic interpretation from diagnostic data received from a diagnostic source. The diagnostic interpretation is produced automatically using a voice recognition system. Along with the transcription of the interpretation, the voice recognition system returns a level of confidence of the voice recognition. Based on this level of confidence, the system automatically routes the transcribed interpretation to the appropriate destination for further processing.

### BACKGROUND OF THE INVENTION

Historically, a patient in need of a particular radiological service is sent to an imaging center by a physician from a medical facility. The imaging may be magnetic resonance imaging (MRI) or computed axial tomography (CT image scans). The imaging center may be part of the medical facility or contracted by the medical facility to perform the diagnostic imaging prescribed by a physician. Typically, the personnel performing the prescribed diagnostic imaging are technicians trained to operate the particular imaging device. The diagnostic imaging source obtains images of the patient as prescribed by the physician Generally, the personnel at the radiological imaging center then forward the diagnostic data about the patient to a data processing center. Of the medical facility. The diagnostic data is then sent to one or more reading physicians (for example reading radiologists) for interpreting the diagnostic data. Previously, the reading radiologist provided a written interpretation. Recently, voice recognition (VR) systems have been employed where the reading radiologist verbally dictates the interpretation into a processing component in which a VR system resides. The VR system then automatically produces a transcription form the verbal dictation of the reading radiologists. The VR system returns a transcription and may also include a level of accuracy of the recognition performed. Heretofore, the report was returned to the reading radiologist for review and correction. Each reading radiologist had to read and review every report no matter what level of confidence the VR system reported about the transcription. This manual step caused increased turnaround times of the radiologists report and also caused additional workload for the reading radiologist.

Thus, a need exists for a system and method to optimize the workflow of the diagnostic reports resulting in faster turnaround times and greater utilization of the reading radiologist's time which will ultimately lead to better patient care. Such a system may provide automated routing of the diagnostic reports to one or more sources.

### BRIEF SUMMARY OF THE INVENTION

Certain embodiments of the present invention include a diagnostic report routing system comprising a user interface adapted to receive an image from a database, a voice recognition component, and a routing component.

Certain embodiments of the present invention provide a method of automatically routing a transcription based on the level of quality including receiving a verbally dictated image interpretation, automatically transcribing the verbal dictation using voice recognition software, generating a transcription that is rated for quality, and automatically routing transcribed interpretation of diagnostic image based on the quality of the transcription.

Certain embodiments of the present invention provide a computer-readable medium including a set of instructions for execution on a computer, the set of instructions including a user interface routine adapted to receive an image from a database, a voice recognition routine capable of producing a transcription from a verbal dictation, and a routing routine capable of routing the transcription based on a level of accuracy of the transcription

### BRIEF DESCRIPTION OF SEVERAL VIEWS OF THE DRAWINGS

FIG. 1 illustrates a system for automatically routing transcribe diagnostic image interpretations in accordance with an embodiment of the present invention

FIG. 2 illustrates a flow diagram for a method of routing transcriptions in accordance with an embodiment of the present invention

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

As illustrated in the drawings the diagnostic report routing system is designed particularly for use in routing a diagnostic image interpreter's reading to appropriate sites based on the quality of the voice recognition.

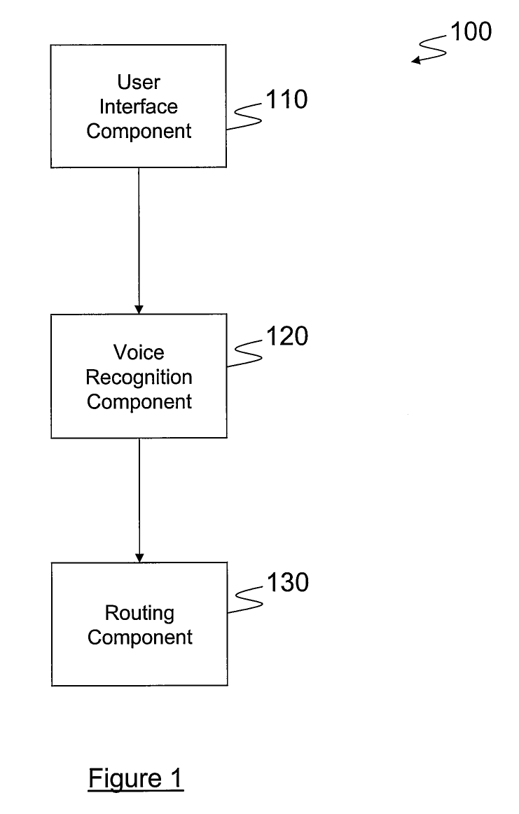

FIG. 1 illustrates generally a block diagram 100 of the routing system. The system 100 includes a user interface component 110, a voice recognition component 120, and a routing component 130.

The user interface component 110 may be in communication with a database which contains diagnostic data about a patient received from a diagnostic source. The raw images from the diagnostic imaging source, such as an MRI, may be sent to the user interface component 110 so that the user or reading physician, such as a radiologist, can interpret the diagnostic data in order to generate interpretations of the diagnostic data or images. It is contemplated that the user interface may receive diagnostic data via a network. In operation, the user interface 110 is adapted to display images to a user. It is contemplated that the user may be a physician or reading radiologist. For example, a radiologist may utilize the user interface component 110 to view a set of CT image scans or MRI images for a particular patient for the purpose of interpreting those images.

It is contemplated that the reader, such as a radiologist interpreting an MRI or CT image, may dictate the interpretation of the images into the voice (speech) recognition component 120. It is contemplated that VR component 120 will convert a speech signal to a sequence of words in the form of digital data by means of an algorithm implemented as a computer program. It is also contemplated that the voice recognition component 120 will return a confidence level of the speech recognition performed. It is further contemplated that the reading physician or radiologist dictates into a digital speech recognition system contained in the voice recognition component 120. It is contemplated that the voice may be routed through a speech recognition engine and a digital document is produced. The digital document along with the confidence level of the accuracy of the recognition performed may be routed to the routing component 130. It is contemplated that the routing component 130 may be a computer program that compares the confidence level of the accuracy of the speech recognition and routes the digital document produced by the voice recognition component 120 to a predetermined destination based on different ranges of the levels of accuracy of the voice recognition. It is contemplated that in one embodiment, the levels are configurable based on user's requirements.

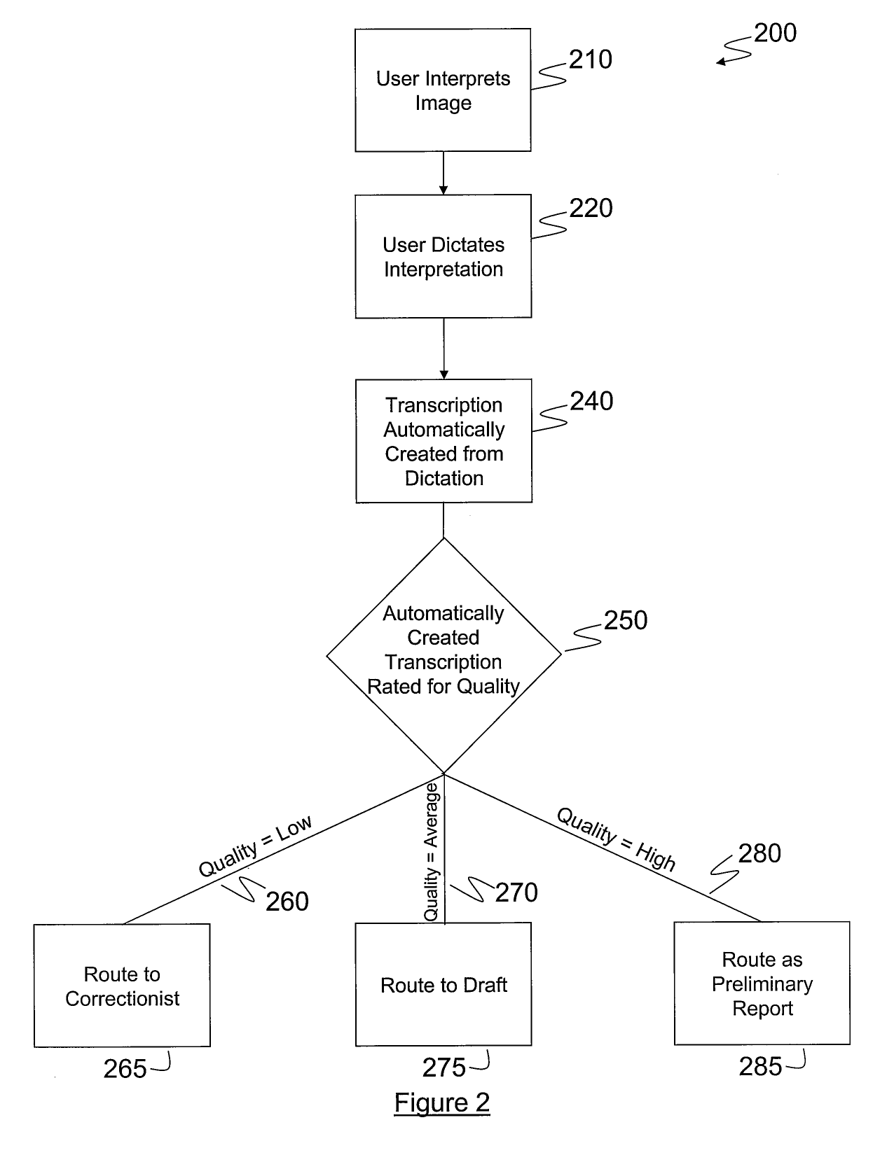

FIG. 2 illustrates an exemplary flow diagram 200 for a method for routing the digital document according to an embodiment of the present invention. The method includes the following steps which will be described below in more detail. At step 210 a reader receives and interprets a diagnostic image. In step 220, the reader dictates the interpretation into a digital dictation system. In step 240, a speech recognition system automatically creates a digital transcription. In step 250, the transcription is rated for quality or accuracy of the speech recognition. Based on the level of accuracy or quality of the speech recognition, the transcription is routed to the appropriate destination. If quality 260 is low, the transcription rated for quality 250 may be routed to correctionist 265. If quality 270 is average, the transcription rated for quality 250 may be routed 270 as a draft document 275. If the quality 280 is high, the transcription rated for quality 250 may be routed as a preliminary report 285.

At step 210, the image is received. The image received may be a diagnostic image such as a MRI image or a CT image scan. The diagnostic images may be forwarded from a diagnostic service source or from a data processing center of the medical facility. It is contemplated that the images may be displayed to reader who preferably is a physician with the appropriate credentials, more particularly, the reader may be a radiologist. The reader or interpreter views the diagnostic images and interprets or reads the images.

In step 220, the reader or interpreter may dictate the interpretation of the images into a digital dictation system. This voice is then routed to a voice recognition engine.

In step 240, a voice recognition engine preferably automatically creates a digital document from the dictation of step 220 by means of an algorithm preferably implemented in a computer program. It is contemplated that in step 240 a transmissible, readable digital file containing the transcription of the reader's interpretation is produced. The transcription along with the original voice file may be contained in the readable digital file.

At step 250, the digital document produced in step 240 is preferably analyzed by the voice recognition engine for accuracy and a confidence level of accuracy of the transcription of the dictation of the reading or interpretation 220 is automatically created. It is contemplated that this confidence level of accuracy is produced by means of an algorithm in a computer program.

If the quality is low 260, the digital document or transcription along with the original voice file may be automatically routed to a correctionist 265 for manual correction. It is contemplated that after the correctionist makes the corrections, the transcription is routed to the reader for review and signature. Correctionists follow prepared a worklist of procedures to follow if the transcription is routed to the correctionist.

If the quality of the transcription in step 250 is average 270, the digital document or transcription along with the original voice file may be labeled as a draft report 275 and automatically routed to the reader for review, correction and signature.

If the quality of the transcription in step 250 is rated as high 280, the transcription is automatically routed as a preliminary report.

In one embodiment, the transcription preliminary report labeled as high quality is routed to the reading physician for signature.

In certain embodiments, the transcription labeled as a preliminary report may be sent to other authorized users such as the referring physician.

In another embodiment, it is contemplated that the transcription labeled as preliminary report may be automatically routed to the insure of the patient to facilitate payment of various services by the insurance provider.

It is further contemplated that the confidence level as a basis for routing of the transcription may not be predefined in the routing component 130, but may be configurable by the provider. For example, the system may be configured so that the routing component 130 never routes a transcription as preliminary report automatically, but only routes the transcription to a correctionist or a draft to reader. Further, it is contemplated that the routing component may be configured to route the transcription only to the reader as a draft.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A diagnostic report routing system comprising:
a user interface adapted to receive an image from a database;
a voice recognition component;
a routing component.

2. The system of claim 1, wherein the database contains a diagnostic image from a diagnostic source.

3. The system of claim 1, wherein the user interface is connected to the database via a network.

4. The system of claim 2, wherein the diagnostic image is a magnetic resonance image.

5. The system of claim 2, wherein the diagnostic image is a CT image scan.

6. The system of claim 1, wherein the voice recognition component contains voice recognition logic.

7. The system of claim 6, wherein the voice recognition logic is a an algorithm implemented as a computer program.

8. The system of claim 1, wherein the routing component contains an algorithm to generate a level of confidence of a speech recognition conversion.

9. The system of claim 8, wherein the routing component automatically routes the speech recognition conversion based the level of confidence.

10. A method for routing a diagnostic report based on quality of user's report dictation comprising:
receiving a diagnostic image;
interpreting the diagnostic image;
dictating a diagnostic interpretation;
automatically creating a transcription from the diagnostic interpretation using a voice recognition system;
automatically rating the transcription created by the voice recognition system for a quality of the voice recognition;
automatically routing the transcription based on the quality of the voice recognition to an appropriate user.

11. The method of claim 10, wherein the diagnostic image is a magnetic resonance image.

12. The method of claim 10, wherein the diagnostic image is a CT image scan.

13. The method of claim 10, wherein the interpretation of the diagnostic image is performed by a physician.

14. The method of claim 10, wherein the rating of quality of the voice recognition is by means of a algorithm implemented into a computer program.

15. The method of claim 14, wherein the rating of quality of the voice recognition is based on an accuracy of the transcription.

16. The method in claim 14, wherein the transcription is routed to a correctionist based on a low accuracy of recognition of a dictated interpretation.

17. The method in claim 14, wherein the transcription is routed to an interpreter for correction and signature based on an average recognition of a dictated interpretation.

18. The method in claim 14, wherein the transcription is routed as a preliminary report based on a high level of recognition of a dictated interpretation.

19. The method of claim 10, wherein the routing of the transcription based on quality is configurable by a provider.

20. A computer-readable medium including a set of instructions for execution on a computer, the set of instructions comprising:
a user interface routine adapted to receive an image from a database;
a voice recognition routine capable of producing a transcription from a verbal dictation;
a routing routine capable of routing the transcription based on a level of accuracy of the transcription.
